(19) United States
(12) Patent Application Publication
(10) Pub. No.: US 2008/0295778 A1
(43) Pub. Date: Dec. 4, 2008

(54) ANIMAL LITTER WITH COLORIMETRIC INDICATOR

(76) Inventors: Jamie K. Pero, Fremont, CA (US); Bradley L. Kirsch, Pleasanton, CA (US)

Correspondence Address: THE CLOROX COMPANY, P.O. BOX 24305, OAKLAND, CA, 94623-1305, US

(21) Appl. No.: 11/756,846

(22) Filed: Jun. 1, 2007

(51) Int. Cl. A01K 1/01; A01K 29/00

(52) U.S. Cl. 119/173; 119/171

(57) ABSTRACT

An extension of the use of calorimetric indicators in clumping litter is to utilize indicators as a visual confirmation that the litter has become soiled. However, all clumping animal litter is susceptible to some degree of crumbling. Since it is the crumbling of a clump that allows soiled litter to remain and propagate malodors, attaching an indicator that undergoes a color change informs the litter user that it is time to change the litter.

### DESCRIPTION OF RELATED ART

1. Field of the Invention

The present invention relates generally to an animal litter that gives the consumer a visible indication that the litter has been soiled by an animal.

2. Description of the Related Art

The use of indicator dyes in animal litter technologies has been applied to litter products used in at-home feline diagnostic applications.

U.S. Pat. No. 5,143,023 to KleanHeart Inc. describes a litter with a visual indicator bound to the litter base material (various clay based litters) for diagnostic purposes. This requires the prior neutralization of surplus charges in the native clay to prevent reaction of the pH indicator with the base material. Other patents and patent applications that discuss pH indicators in animal litter include: U.S. Pat. No. 5,267,532 to Anitox Corporation, U.S. Pat. No. 5,371,054 to Engelhard Corporation, U.S. Pat. No. 5,685,259 and U.S. Pat. No. 5,783,085 to Ranpak Corp., U.S. Pat. No. 3,978,818 to Heldenbrand, U.S. Pat. No. 6,162,646 to William H. Webster, US 20060102085 A1 to Joey Chen, and U.S. Pat. No. 6,019,062 to Lombard. Procter & Gamble patents U.S. Pat. No. 6,713,660B1, U.S. Pat. No. 6,399,853, and U.S. Pat. No. 6,342,037 are also of interest.

The advent of clumping litter provided a means by which most of the soiled litter can be removed from the bulk of the unsoiled litter. However, every clump is susceptible to some degree of crumbling. Resultantly, with the removal of every clump, there is a small amount of soiled litter that remains in the box. Furthermore, the litter is subjected to malodors produced during defecation that also soil the litter. Litter users rely on either their olfactory senses or an arbitrary time to decide when it is appropriate to completely change the litter.

The present invention provides for the addition of an indicator that changes color in response to either pH, ammonia level, some specific gas produced by solid waste, or a combination of these that allows the consumer to visually see that the litter has absorbed the maximum odor that it can.

One of the most common and distressing household odors is caused by pets, such as cats, who must void or eliminate in the home in discrete areas, such as litter boxes or other containment devices. The typical litter box must contain in the neighborhood of 5 to 20 pounds of litter to effectively absorb and/or control pet odors and waste products. Typical litter products are sold in packages ranging in size from about 5 to 50 pounds and costing approximately $5.00 to $50.00. Thus, it is desirable to have a device that is easily distributed to a large number of people, is user-friendly and allows the consumer to evaluate the odor-controlling effectiveness of a litter product at his/her convenience.

### SUMMARY OF THE INVENTION

An object of the invention includes an animal litter that comprises an absorbent material and a material that undergoes a visible color change upon contact with ammonia.

Another object of the invention includes an animal litter that comprises an absorbent material and a material that undergoes a visible color change upon contact with animal fecal material.

### DETAILED DESCRIPTION

Before describing the present invention in detail, it is to be understood that this invention is not limited to particularly exemplified systems or process parameters as such may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to an “odor controlling agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

All numbers expressing quantities of ingredients, constituents, reaction conditions, and so forth used in the specification and claims are to be understood as being modified in all instances by the term “about”. Notwithstanding that the numerical ranges and parameters setting forth the broad scope of the subject matter presented herein are approximations, the numerical values set forth in the specific examples are reported as precisely as possible. All numerical values, however, inherently contain certain errors necessarily resulting from the standard deviation found in their respective testing measurements.

As used herein the term “absorbent material suitable for use as an animal litter” refers to the many liquid-absorbing materials and combinations thereof disclosed herein as well as any other liquid-absorbing materials or combinations thereof known to those having ordinary skill in the art. Most commonly those materials include clays such as sodium and calcium bentonites, silica gels and cellulosic materials such as saw dust and paper pulp.

As used herein, the terms “scoopable” and “clumping litter” refer to a litter that agglomerates upon wetting such that the soiled portion can be removed from the litter box leaving the unsoiled portion available for reuse.

Examples of commonly used materials include clays, such as kaolinite and bentonite (e.g., sodium bentonite and calcium bentonite); organic materials such as straw, sawdust, wood, paper, and cellulose; and silica gels. The absorbent particles may range in particle size from about 150 μm to about 5 mm (4-100 mesh) and can represent raw materials or composite particles.

As used herein the term “composite particle” means a particle formed by combining smaller discrete particles of either the same composition or different compositions such that the resulting particle, i.e., the “composite particle”, is a particle having structural integrity that is of a particle size bigger than that of its component parts. The composite particles useful for animal litter can range in particle size between about 150 μm and about 5 mm and are typically between about 350 μm and about 3 mm.

As used herein the term “composite blend” refers to a dry mixing of the composite particles of the present invention and one or more additional absorbent litter materials and/or other litter additives or the dry mixing of composite particles having different compositions, and/or combinations thereof.

As used herein the terms “litter additives” or “other materials suitable for use as litter additives” refer to performance-enhancing actives as described herein as well as other additives known to be used in litter compositions by those having ordinary skill in the art.

The following description includes embodiments presently contemplated for carrying out the present invention. A common type of litter is clay and a good odor absorber used in combination with the clay is activated carbon. Thus, much of the discussion will be directed to clumping clay litter and particularly clumping clay litter with odor absorbing actives such as boron compounds and/or activated carbon. This description is made for the purpose of illustrating the general principles of the present invention and is not meant to limit the inventive concepts claimed herein. Thus, it should be understood that the present invention is suitable for all types of animal litter, inclusive of those with and without the addition of active ingredients that function to enhance odor control.

An extension of the use of calorimetric indicators in litter is to utilize indicators as a visual confirmation that the litter has become soiled. For example, a chart could be placed on each box of litter with a color scale (similar to charts used with pH paper) that illustrates for the consumer the color at which the litter can absorb little or no more odor by means of the activated carbon and/or clay. The consumer can then discern that it is time to change the litter to prevent a negative olfactory experience from malodors emanating from the litter box.

Consumers have identified malodor as one of the issues of central importance surrounding the use of animal litters. The addition of activated carbon in clay litter has decreased the amount of malodor emanating from the litter box. However, there is a point at which the activated carbon has absorbed all the odor that it can. At this point, the litter must be discarded.

Stronger clumps aid in the removal of soiled odiferous litter. However, all clumping animal litter is susceptible to some degree of crumbling. The incorporation of a calorimetric detector specific to feline waste malodor possibly circumvents the need for a stronger clump. Since it is the crumbling of a clump that allows soiled litter to remain and propagate malodors, attaching an indicator that underwent a color change informing the litter user that it is time to change the litter may alleviate the negative impact of clump crumbling.

Similarly, solid waste can be scooped by the animal owner to remove the odiferous waste from the litter. However, oftentimes a portion of the solid waste tends to break off and remains in the litter, generally hidden from sight, to propagate malodors. By attaching an indicator that undergoes a color change when contacted with one or more compounds contained in solid waste, the user is informed that additional scooping is necessary. Thus, the need to change the entire litter contained in the box may be alleviated.

The simplest and fastest way to obtain the desired color change would be by way of a pH indicator dye. By choosing a pH indicator that changes at a pH of 6-8, feline urine can be detected. For example, U.S. Pat. No. 5,143,023 to KleanHeart Inc. describes a litter with a visual indicator bound to the litter base material (various clay based litters) for diagnostic purposes. This requires the prior neutralization of surplus charges in the native clay to prevent reaction of the pH indicator with the base material.

Another possible approach would be to attach an ammonia detector to either the primary litter material (e.g., bentonite) or to a litter additive such as silica particles. This is advantangeous because it provides a more specific method of detection for malodors. Several possible avenues exists for the development of ammonia detection.

For instance, Nessler's reagent (K₂HgI₄) is a common reagent used for the calorimetric detection of gaseous ammonia. The toxicity of a mercury containing compound presents a hurdle that would need to be circumvented.

Alternatively, there exists on the market today simple calorimetric test kits for ammonia detection. These kits contain a silica bead coated with sulfuric acid and a pH indicator. The gaseous ammonia reacts with the sulfuric acid and is visualized with the indicator. In this scenario, the use of sulfuric acid in a consumer friendly way would need to be addressed. Other utilizable means by which ammonia detection can be accomplished are likely suitable for use in animal litter as well. Typically, the indicator comprises about 1% by weight of the litter composition, but can range from 0.1-10% by weight of the litter composition.

A sample animal litter formula that provides calorimetric detection of ammonia includes an absorbent material suitable for use as an animal litter (e.g., sodium bentonite) and about 1% carrier particle (e.g., silica bead or zeolite) coated with a strong acid (e.g., sulfuric acid) and a pH indicator that changes color above pH 7 (e.g., Bromothymol blue, Phenol Red, Neutral Red, Cresol Red, α-natholpthalein, Cresol purple, Thymol blue, phenothalein, or thymolpthalein) or about 1% litter substrate coated with Nessler's Reagent (K₂HgI₄). Other additives that can be included along with the absorbent material include litter filler materials (e.g., limestone), odor controlling additives (e.g., boron compounds and/or activated carbon), odor masking additives (e.g., fragrances) and/or other performance-enhancing actives.

Gas chromatograph analysis on feline fecal waste could identify the gases responsible for malodor emanating from feces and a calorimetric indicator of these gases could be incorporated into the animal litter.

Because of the wide variety of malodor compounds that are present in real cat waste, there are a number of formulas that could be used for an odor indicating litter. Scoopable and non-clumping animal litters can be formulated to visually indicate the presence of fecal waste by including indicating materials that are sensitive to compounds found in fecal waste.

The following embodiments of formulas would be useful in alerting the consumer to the presence of fecal waste and thus the presence of used litter in the litter box. These formulas are for exemplary purposes only and are not meant to be limiting, as they can be adapted to include indicators for any of the myriad compounds present in cat waste. Typically, the indicator comprises about 1% by weight of the litter composition, but can range from 0.1-10% by weight of the litter composition.

As clays tend to be basic, the indicators are positioned on carrier particles, such as silica gel or zeolite, to minimize reaction with the clay itself. However, the indicators can also be included directly on the clay and do not necessarily need to be present on a carrier particle.

One embodiment of an animal litter formula that provides detection of mercaptan compounds in litter comprises an absorbent material suitable for use as an animal litter (e.g., sodium bentonite) and 1% silica bead coated with palladium sulfate indicator. Other additives that can be included along with the absorbent material include litter filler materials (e.g., limestone), odor controlling additives (e.g., boron compounds and/or activated carbon), odor masking additives (e.g., fragrances) and/or other performance-enhancing actives.

A second embodiment of an animal litter formula that provides detection of mercaptan compounds in litter comprises an absorbent material suitable for use as an animal litter (e.g., sodium bentonite) and 1% silica bead coated with mercuric chloride in the presence of a pH indicator that changes color at a pH above 7, such as Bromothymol blue, Phenol Red, Neutral Red, Cresol Red, α-natholpthalein, Cresol purple, Thymol blue, phenothalein, or thymolpthalein). Typically the indicator will change color in the pH 7-10 range. Other additives that can be included along with the absorbent material include litter filler materials (e.g., limestone), odor controlling additives (e.g., boron compounds and/or activated carbon), odor masking additives (e.g., fragrances) and/or other performance-enhancing actives.

A sample animal litter formula that provides detection of Acetic Acid in litter includes an absorbent material suitable for use as an animal litter (e.g., sodium bentonite) and 1% silica bead coated with a strong base (e.g., sodium hydroxide) in the presence of a pH indicator that changes color at a pH above 7, such as Bromothymol blue, Phenol Red, Neutral Red, Cresol Red, α-natholpthalein, Cresol purple, Thymol blue, phenothalein, or thymolpthalein. Typically the indicator will change color in the pH 7-10 range. Other additives that can be included along with the absorbent material include litter filler materials (e.g., limestone), odor controlling additives (e.g., boron compounds and/or activated carbon), odor masking additives (e.g., fragrances) and/or other performance-enhancing actives.

A sample animal litter formula that provides detection of Propyl Acetate in litter includes an absorbent material suitable for use as an animal litter (e.g., sodium bentonite) and 1% silica bead coated with chromium oxide in the presence of sulfuric acid. Other additives that can be included along with the absorbent material include litter filler materials (e.g., limestone), odor controlling additives (e.g., boron compounds and/or activated carbon), odor masking additives (e.g., fragrances) and/or other performance-enhancing actives.

The invention claimed is:

1. An animal litter comprising:
an absorbent material suitable for use as an animal litter; and
a material that undergoes a visible color change upon contact with animal fecal material.

2. The animal litter recited in claim 1, wherein the absorbent material comprises bentonite clay.

3. The animal litter recited in claim 1, wherein the material that undergoes a visible color change is a basic compound that is in the presence of a pH indicator that changes color above pH 7.

4. The animal litter recited in claim 3, wherein the basic compound is an alkaline hydroxide.

5. The animal litter recited in claim 1, wherein the material that undergoes a visible color change reacts with a mercaptan compound.

6. The animal litter recited in claim 1, wherein the material that undergoes a visible color change reacts with acetic acid.

7. The animal litter recited in claim 1, wherein the material that undergoes a visible color change reacts with propyl acetate.

8. The animal litter recited in claim 1, wherein the material that undergoes a visible color change is palladium sulfate.

9. The animal litter recited in claim 1, wherein the material that undergoes a visible color change is mercuric chloride.

10. The animal litter recited in claim 1, wherein the material that undergoes a visible color change is an alkaline hydroxide in the presence of a pH indicator, wherein the pH indicator changes color at a pH above 7.

11. The animal litter recited in claim 1, wherein the material that undergoes a visible color change is an alkaline hydroxide in the presence of a pH indicator, wherein the pH indicator changes color between pH 7 and pH 10.

12. The animal litter recited in claim 1, wherein the material that undergoes a visible color change is chromium oxide in the presence of sulfuric acid.

13. The animal litter recited in claim 1, wherein the material that undergoes a visible color change is loaded onto a carrier particle.

14. The animal litter recited in claim 13, wherein the carrier particle is silica gel, zeolite, or a clay different from the absorbent material suitable for use as an animal litter.

15. The animal litter recited in claim 13, wherein the material that undergoes a visible color change comprises between 0.1-10% by weight of the litter composition.

16. An animal litter comprising:
an absorbent material suitable for use as an animal litter; and
a material that undergoes a visible color change upon contact with ammonia.

17. The animal litter recited in claim 16, wherein the material that undergoes a visible color change is K₂HgI₄.

18. The animal litter recited in claim 17, wherein the K₂HgI₄ is coated onto about 1% by weight of the absorbent material.

19. The animal litter recited in claim 16, wherein the material that undergoes a visible color change is silica gel coated with sulfuric acid and a pH indicator that changes color above pH 7.
